(19) United States
(12) Patent Application Publication
(10) Pub. No.: US 2009/0059320 A1
(43) Pub. Date: Mar. 5, 2009

(54) Magnification Controlling System Used In An Image Forming Apparatus

(75) Inventor: Yueh-Shing Lee, Hsinchu (TW)

Correspondence Address: WPAT, PC;INTELLECTUAL PROPERTY ATTORNEYS, 2030 MAIN STREET, SUITE 1300, IRVINE, CA, 92614, US

(73) Assignee: Foxlink Image Technology Co., Ltd., Hsinchu (TW)

(21) Appl. No.: 11/847,215

(22) Filed: Aug. 29, 2007

(51) Int. Cl. H04N 1/04

(52) U.S. Cl. 358/498

(57) ABSTRACT

A magnification controlling system used in an image forming apparatus has a sensor module for reading a first image and a second image form a document conveyed in a predetermined speed. The first and second images are converted into a base and a reference image by an A/D converter. A processor calculates the shifting offset between the base image and the reference image to produce a reference speed. The processor calculates the predetermined and reference speed to produce a control signal and then sends the control signal to a pulse producing circuit. The pulse producing circuit provides plurality of pulse signals in a predetermined time according to the control signal. The pulse producing circuit sends the pulse signals to a step motor or an image forming module in the image forming apparatus for controlling document conveying speed of the step motor or scanning speed of the image forming module.

### BACKGROUND OF THE INVENTION

1. Field of the Invention

The invention relates to a magnification controlling system. More specifically, an image forming apparatus has the magnification controlling system for controlling document conveying speed or document scanning speed.

2. The Related Art

Rapid innovation and development upon image processing technology have made facsimile products as one of the mainstream products nowadays. One of the popular facsimile products is a scanner because the scanner can read documents and then produces corresponding electronic images. The electronic images are easy stored and easy carried.

Many different types of scanner are used, including a portable type scanner, a flatbed type scanner, an auto document feeding type scanner and a film type scanner. More specifically, the flatbed type scanner and the auto document feeding type scanner are most popular and used in office and home. The flatbed type scanner has a scanning platen, a lamp and an image forming module. A document is located on the scanning platen and the lamp lights the document. Therefore, the image forming module reads the document and then produces a corresponding electronic image.

However, One defect of the flatbed type scanner is that it is need to manually replace the document on the scanning platen when the flatbed type scanner scans many documents. For improving above defect, the auto document feeding type scanner is developed. The auto document feeding type scanner has a tray, a catching roller, a separating roller, a feeding roller, an image forming module and an extracting roller.

Plurality of documents are located on the tray and fed into the auto feeding type scanner by the catching roller. The documents are separated to one by one by the separating roller and conveyed to pass the image forming module in predetermined speed by the feeding roller. Therefore, the image forming module reads the documents and then produces corresponding electronic images. The extracting roller conveys the documents to exit the auto feeding scanner one by one.

When the feeding roller is worn, conveying speed of the feeding roller becomes variable. Magnification of the electronic images is corresponding to conveying speed of the feeding roller. Therefore, the electronic images are blurred due to that the conveying speed of the feeding roller is variable when image forming module reads the documents.

### SUMMARY OF THE INVENTION

An object of the present invention is to provide a magnification controlling system used in an image forming apparatus. The magnification controlling system has a sensor module for reading analog images form a document conveyed at a predetermined speed. The analog images are converted into digital images by an analog-to-digital converter. The digital images are calculating to produce a reference speed by a processor.

The processor also calculates the reference speed and the predetermined speed to produce a control signal. A pulse producing circuit provides plurality of pulse signals in a predetermined time according to the control signal. Therefore, the pulse producing circuit can send the pulse signals to a step motor in the image forming apparatus for controlling document conveying speed. Also, the pulse producing circuit can send the pulse signals to an image forming module in the image forming apparatus for controlling scanning speed of the image forming module.

Another object of the present invention is to provide a controlling method of the magnification controlling system having following steps:

S01: conveying the document at the predetermined speed;

S02: reading a first analog image from the document by the sensor module and then converting the first analog image to a first digital image by the analog-to-digital converter, setting the first digital image to the base image and storing the base image;

S03: reading a second analog image from the document by the sensor module and then converting the second analog image to a second digital image by the analog-to-digital converter, setting the second digital image to the reference image;

S04: calculating the base image and the reference image to produce the reference speed;

S05: calculating the predetermined speed and the reference speed, if the predetermined speed is equal to the reference speed value, executes S07, if the predetermined speed value is not equal to the reference speed value, executes S06;

S06: calculating the predetermined speed and the reference speed to produce the control signal, adjusting amount of pulse signals in a predetermined time according to the control signal; and

S07: setting the reference image to the base image and then executing S03.

Therefore, the pulse signals can be sent to the step motor in the image forming apparatus for controlling document conveying speed. Also, the pulse signals can be sent to the image forming module in the image forming apparatus for controlling scanning speed of said image forming module.

### BRIEF DESCRIPTION OF THE DRAWINGS

The present invention will be apparent to those skilled in the art by reading the following description of a preferred embodiment thereof, with reference to the attached drawings, in which:

FIG. 1 shows a sensor module of a magnification controlling system configured in a scanner according to the present invention;

FIG. 2 is a block diagram showing a first preferred embodiment of the magnification controlling system according to the present invention;

FIG. 3 is a flow chart illustrating procedure of the magnification controlling system according to the present invention;

FIG. 4a, FIG. 4b and FIG. 4c show sequential images read by the sensor module when a feeding roller rotates in a predetermined speed according to the present invention;

FIG. 5 shows PWM signal produced by a PWM circuit and trigger signal of the sensor module of the first preferred embodiment when the feeding roller rotates in the predetermined speed according to the present invention;

FIG. 6a, FIG. 6b and FIG. 6c illustrates sequential images read by the sensor module when the feeding roller rotates in variable speed according to the present invention;

FIG. 7 shows PWM signal produced by the PWM circuit and trigger signal of the sensor module of the first preferred embodiment when the feeding roller rotates in variable speed according to the present invention;

FIG. 8 is a block diagram showing a second preferred embodiment of the magnification controlling system according to the present invention;

FIG. 9 illustrates PWM signal produced by the PWM circuit and trigger signal of the sensor module of the second preferred embodiment when the feeding roller rotates in the predetermined speed according to the present invention; and

FIG. 10 illustrates PWM signal produced by the PWM circuit and trigger signal of the sensor module of the second preferred embodiment when the feeding roller rotates in variable speed according to the present invention.

### DETAILED DESCRIPTION OF THE PREFERRED EMBODIMENT

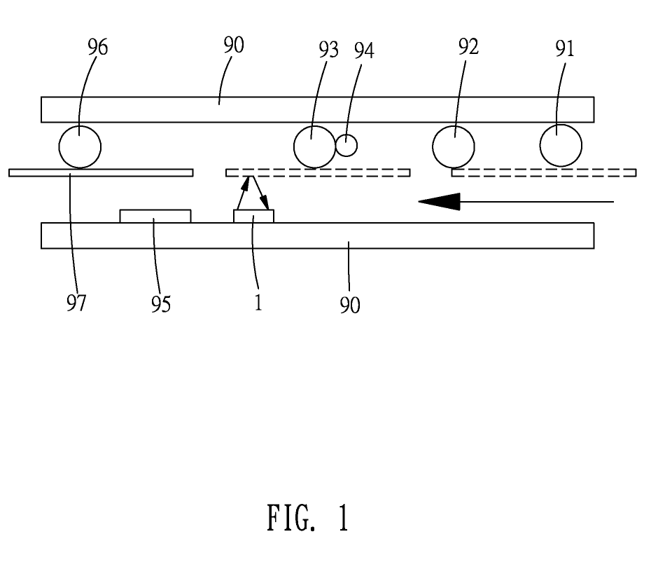

Please refer to FIG. 1. A magnification controlling system 100 can used in facsimile products, such as scanner, copy machine, etc. In this case, the magnification controlling system is used in a scanner. The scanner has a housing 90 and defines a feeding path. A catching roller 91, a separating roller 92, a feeding roller 93, a step motor 94 connecting the feeding roller 93, an image forming module 95 and an extracting roller 96 are arranged on the feeding path of the scanner.

The catching roller 91 catches documents 97 and conveys the documents 97 to the separating roller 92. The separating roller 92 separates the documents 97 and conveys the documents 97 to the feeding roller 93 one by one. The feeding roller 93 conveys the documents 97 to pass through the image forming module 95 one by one in a predetermined speed which is controlled by the step motor 94. Therefore, the image forming module 95 reads the documents 97 one by one and then produces electronic images corresponding to the documents 97. Finally, the extracting roller 96 extracts the documents 97 from the feeding path of the scanner one by one.

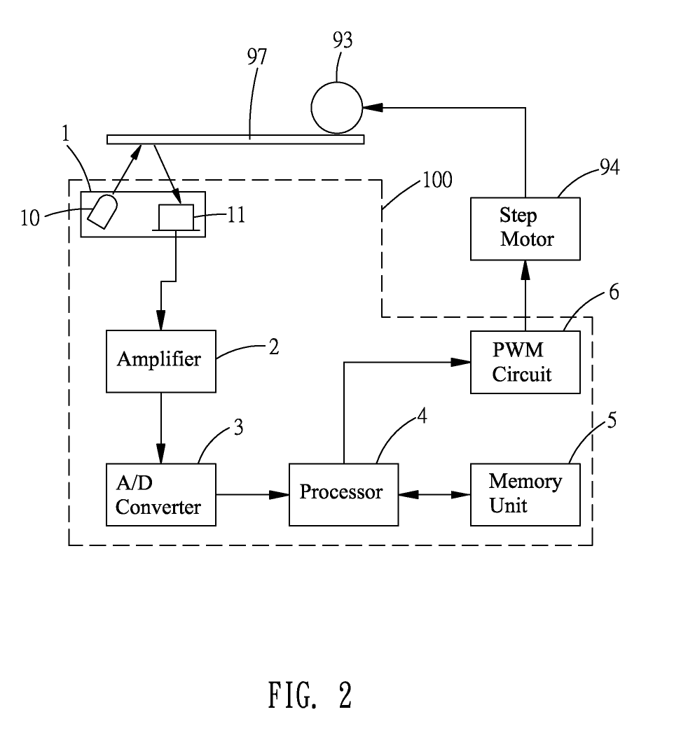

Please refer to FIG. 2. The magnification controlling system 100 has a sensor module 1, an amplifier 2 connecting the sensor module 1, an analog-to-digital (A/D) converter 3 connecting the amplifier 2, a processor 4 connecting the A/D converter 3, a memory unit 5 connecting the processor 4 and a pulse width modulation (PWM) circuit 6 connecting the processor 4. In this case, the sensor module 1 is arranged between the feeding roller 93 and the image forming module 95. The sensor module 1 has a lamp 10 and a sensor II. In this case, the lamp 10 is a light-emitting diode (LED) and the sensor II is a charge-coupled device (CCD).

When the documents 97 are conveyed to pass through the sensor module 1 one by one by the feeding roller 93, the lamp 10 lights a predetermined area of documents 97 and then the sensor 11 reads an analog image from the predetermined area of the documents 97. The amplifier 2 amplifies the analog image read by the sensor 11 and sends the amplified analog image to the A/D converter 3. The A/D converter 3 converts the amplified analog image to a digital image and then sends the digital image to the processor 4.

When the processor 4 receives the digital image from the A/D converter 3, the digital image is set to the base image and stored in the memory unit 5. When the processor 4 receives the digital image from the A/D converter again, the digital image is set to the reference image. The processor 4 calculates the base image and the reference image and then produces a reference speed.

In this case, the memory unit 5 stores the predetermined speed. The processor 4 calculates the reference speed and the predetermined speed to produce a control signal and then sends the control signal to the PWM circuit 6. The PWM circuit 6 produces a PWM signal according to the control signal.

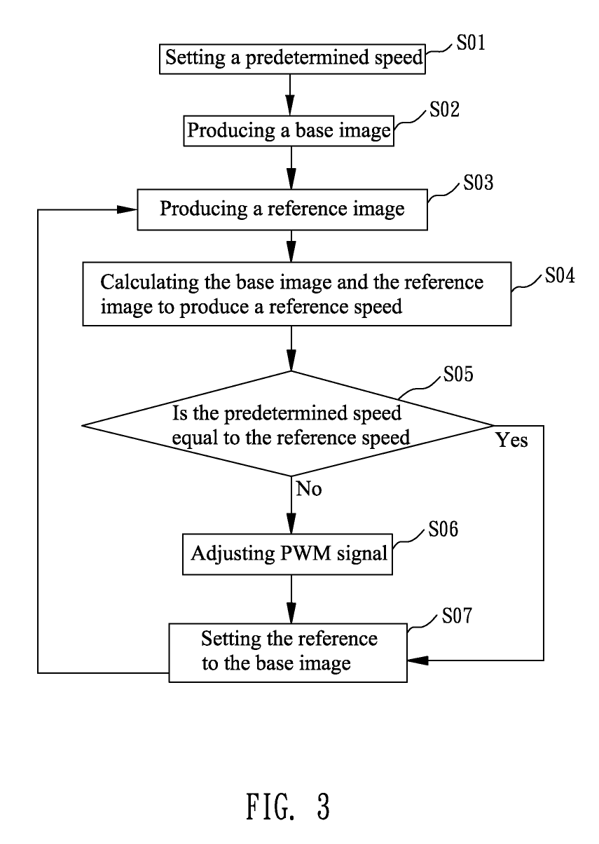

Please refer to FIG. 3. The procedure of the magnification controlling system has following steps:

S01: means for storing the predetermined speed in the memory unit 5;

S02: reading the analog image from the predetermined area of the documents 97 by the sensor module 1 and then converting the analog image to the digital image by the A/D converter 3, setting the digital image to the base image and storing the base image in the memory unit 5 by the processor 4;

S03: reading the analog image from the predetermined area of the documents 97 by the sensor module 1 and then converting the analog image to the digital image by the A/D converter 3 again, setting the digital image to the reference image by the processor 4;

S04: calculating the base image and the reference image to produce the reference speed value by the processor 4;

S05: comparing the predetermined speed value and the reference speed value by the processor 4, if the predetermined speed value is equal to the reference speed value, executes S07, if the predetermined speed value is not equal to the reference speed value, executes S06;

S06: calculating the predetermined speed value and the reference speed value to produce the control signal by the processor 4, adjusting PWM signal produced by the PWM circuit 6 according to the control signal for controlling conveying speed of the feeding roller 93; and

S07: setting the reference image to the base image and then executing S03.

Please refer to FIG, 2 again. In a first embodiment of the magnification controlling system 100, the PWM circuit 6 connects the step motor 94 which connects the feeding roller 93. The PWM circuit 6 sends the PWM signal to the step motor 94 for controlling rotation speed of the step motor 94. Therefore, conveying speed of the feeding roller 93 is corresponding to rotation speed of the step motor 94 which is controlled by the PWM signal produced by the PWM circuit 6.

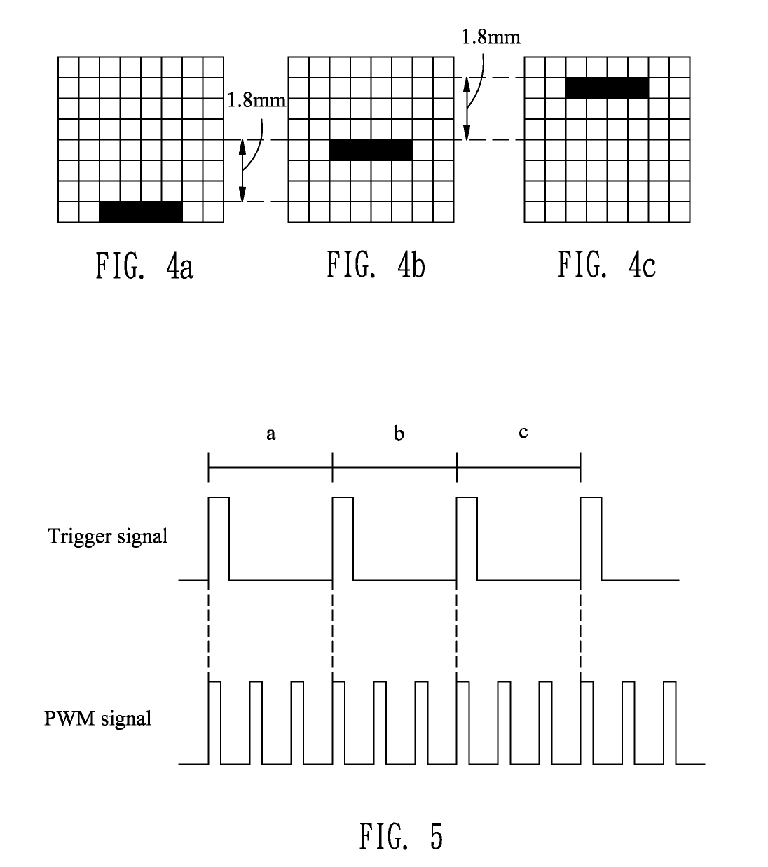

Please refer to FIG. 4a, FIG. 4b and FIG. 4c. FIG. 4a, FIG. 4b and FIG. 4c show digital images which are read by the sensor module 1 and converted by the A/D converter 3 when the feeding roller 93 rotating in predetermined speed. The digital image shown in FIG. 4a and the digital image shown in FIG. 4b is between an interval time. The digital image shown in FIG. 4b and the digital image shown in FIG. 4c is also between the interval time.

Please refer to FIG. 5. In this case, the trigger signal has several pulses for triggering the sensor module 1 to read the image from predetermined area of the documents 97. In this case, each pulse is between 3 millisecond (ms). Therefore, the sensor module 1 reads the image from the predetermined area of the documents 97 once every 3 ms.

In this case, the predetermined speed vale is 0.6 millimeter/ms (mm/ms) which is stored in the memory unit 5. The PWM circuit 6 produces a predetermined PWM signal according to the predetermined speed value and sends the predetermined PWM signal to the step motor 94. In this case, the predetermined PWM signal has several pulses. Each pulse of the predetermined PWM signal is between 1 ms. Each pulse of the predetermined PWM signal triggers the step motor 94 to rotate a predetermined angle.

Therefore, the conveying speed of the feeding roller 93 is corresponding to the rotation angle of the step motor 94 which is controlled by the predetermined PWM signal produced by the PWM circuit 6. The documents 97 is conveyed to pass the image forming module 95 by the feeding roller 93 at the predetermined speed 0.6 mm/ms.

When the image sensor 1 is triggered by the first pulse of the trigger signal (indicator a in FIG. 5) to read the image (FIG. 4a) from the documents 97, the image is converted to the digital image by the A/D converter 3. The image is set to the base image and stored in the memory unit 5. When the image sensor 1 is triggered by the second pulse of the trigger signal (indicator b in FIG. 5) to read the image (FIG. 4b) from the documents 97, the image is converted to the digital image by the A/D converter 3. The image is set to the reference image.

In this case, the image is divided to 8×8 blocks. The width and the length of each block of the image are 0.6 mm. Therefore, the offset between the base image and the reference image is 1.8 mm. The processor 4 calculates the offset and the interval time between the first pulse and the second pulse of the trigger signal to produce the reference speed value which is 0.6 mm/ms.

Because the predetermined speed value is equal to the reference speed value, the PWM circuit 6 still produces the predetermined PWM signal and sends the predetermined PWM signal to the step motor 4. Therefore, the conveying speed of the feeding roller 93 is corresponding to the rotation speed of the step motor 94 controlled by the predetermined PWM signal, which is still 0.6 mm/ms. The reference image is set to the base image and sorted in the memory unit 5.

When the image sensor 1 is triggered by the third pulse of the trigger signal (indicator c in FIG. 5) to read the image (FIG. 4c) from the documents 97, following operation of the magnification controlling system 100 is the same as above description.

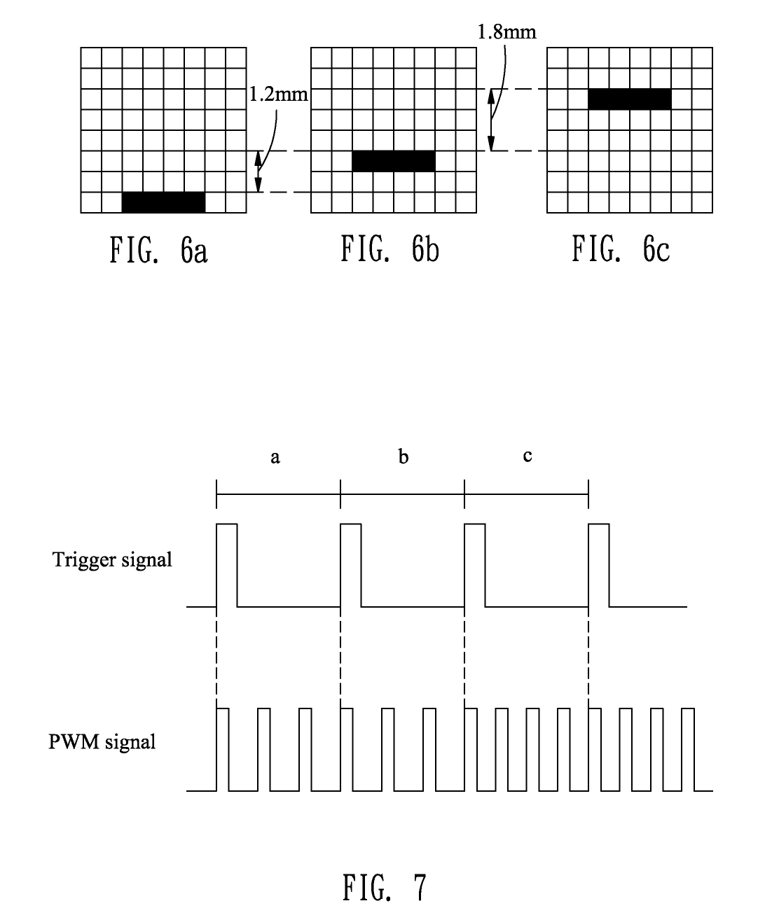

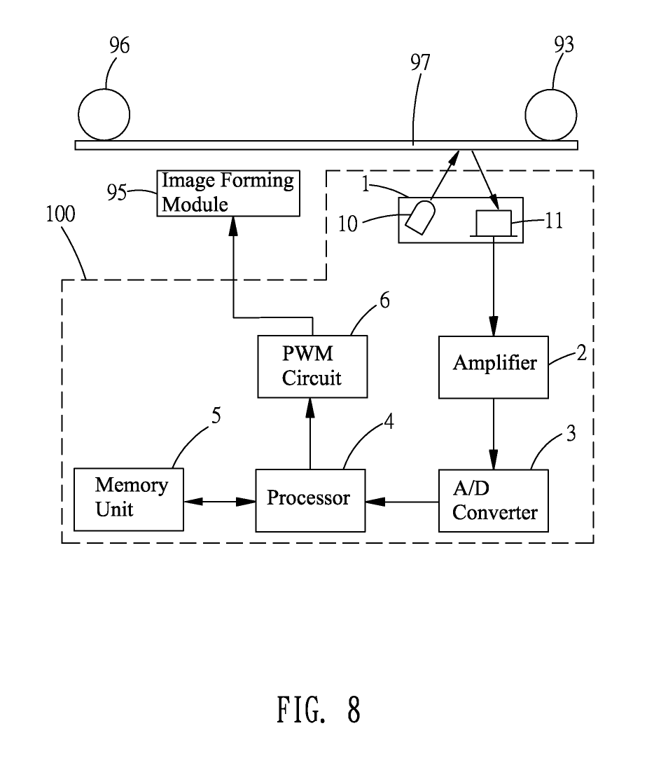

Please refer to FIG. 6a, FIG. 6b and FIG. 6c. FIG. 6a, FIG. 6b and FIG. 6c show digital images which are read by the sensor module 1 and converted by the A/D converter 3 when the feeding roller 93 rotating in variable speed. The digital image shown in FIG. 6a and the digital image shown in FIG. 6b is between the interval time. The digital image shown in FIG. 6b and the digital image shown in FIG. 6c is also between the interval time.

Please refer to FIG. 7. The trigger signal has several pulses for triggering the sensor module 1 to read the image from predetermined area of the documents 97. Each pulse is between 3 millisecond (ms). Therefore, the sensor module 1 reads the image from the predetermined area of the documents 97 once every 3 ms.

In this case, the predetermined speed vale is 0.6 millimeter/ms (mm/ms) which is stored in the memory unit 5. The PWM circuit 6 produces a predetermined PWM signal according to the predetermined speed value and sends the predetermined PWM signal to the step motor 94. In this case, the predetermined PWM signal has several pulses. Each pulse of the predetermined PWM signal is between 1 ms. Each pulse of the predetermined PWM signal triggers the step motor 94 to rotate a predetermined angle.

Therefore, the conveying speed of the feeding roller 93 is corresponding to the rotation angle of the step motor 94 which is controlled by the predetermined PWM signal produced by the PWM circuit 6. The documents 97 is conveyed to pass the image forming module 95 by the feeding roller 93 at the predetermined speed 0.6 mm/ms.

When the image sensor 1 is triggered by the first pulse of the trigger signal (indicator a in FIG. 7) to read the image (FIG. 6a) from the documents 97, the image is converted to the digital image by the A/D converter 3. The image is set to the base image and stored in the memory unit 5. When the image sensor 1 is triggered by the second pulse of the trigger signal (indicator b in FIG. 7) to read the image (FIG. 6b) from the documents 97, the image is converted to the digital image by the A/D converter 3. The image is set to the reference image.

Therefore, the offset between the base image and the reference image is 1.2 mm. The processor 4 calculates the offset and the interval time between the first pulse and the second pulse of the trigger signal to produce the reference speed value which is 0.4 mm/ms.

Because the predetermined speed value is not equal to the reference speed value, the processor 4 calculates the predetermined speed value and the reference speed value to produce the control signal and sends the control signal to the PWM circuit 6. Because the reference speed value is two third of the predetermined speed value, the PWM circuit 6 adjusts the PWM signal to increase rotation speed of the step motor 94. In this case, the PWM circuit 6 produces a pulse every 0.75 ms to improve one third of rotation speed of the step motor 94. Therefore, conveying speed of the feeding roller 93 is improved one third to 0.8 mm/ms.

When the image sensor 1 is triggered by the third pulse of the trigger signal (indicator c in FIG. 7) to read the image (FIG. 6c) from the documents 97, following operation of the magnification controlling system 100 is the same as above description. In this case, the offset between the base image (FIG. 6b) and the reference image (FIG. 6c) is 1.8 mm. The processor 4 calculates the offset and the interval time between the first pulse and the second pulse of the trigger signal to produce the reference speed value which is 0.6 mm/ms.

Because the predetermined speed value is equal to the reference speed value, the PWM circuit 6 still produces the PWM signal and sends the PWM signal to the step motor 4. Therefore, the conveying speed of the feeding roller 93 is corresponding to the rotation speed of the step motor 94 controlled by the predetermined PWM signal, which is still 0.8 mm/ms. The reference image is set to the base image and sorted in the memory unit 5.

Rotation speed of the step motor 94 of the scanner is controlled by the PWM signal produced by the PWM circuit 6 of the magnification controlling system 100. The documents 97 are conveyed to pass to the image forming module 95 by the feeding roller 93 and the conveying speed of the feeding roller 93 is corresponding to the rotation speed of the step motor 94. Therefore, the magnification controlling system 100 controls magnification of the electronic image read by the image forming module 95 by controlling conveying speed of the feeding roller 93.

Please refer to FIG, 8. In a second embodiment of the magnification controlling system 100, the PWM circuit 6 connects the image forming module 95. The PWM circuit 6 sends the PWM signal to the image forming module 95 for controlling scanning speed of the image forming module 95.

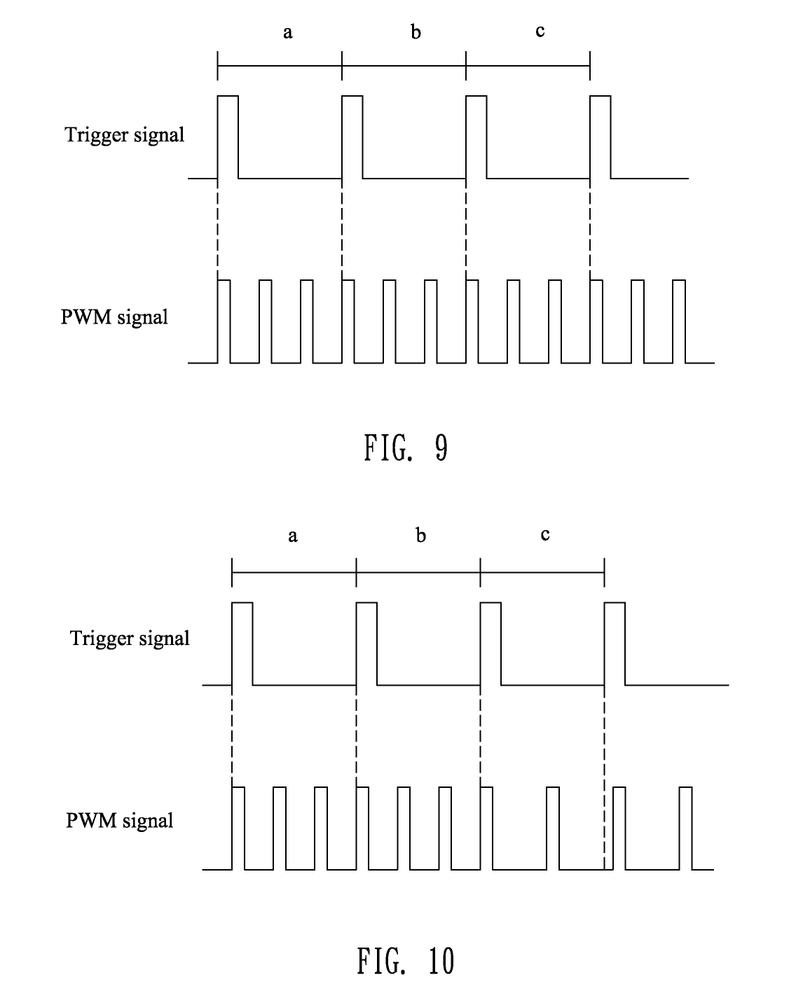

Please refer to FIG. 4a, FIG. 4b, FIG. 4c and FIG. 9. In this case, the trigger signal has several pulses for triggering the sensor module 1 to read the image from predetermined area of the documents 97. In this case, each pulse is between 3 millisecond (ms). Therefore, the sensor module 1 reads the image from the predetermined area of the documents 97 once every 3 ms.

In this case, the predetermined speed vale is 0.6 millimeter/ms (mm/ms) which is stored in the memory unit 5. The PWM circuit 6 produces a predetermined PWM signal and sends the predetermined PWM signal to the image forming module 95. In this case, the predetermined PWM signal has several pulses. Each pulse of the predetermined PWM signal is between 1 ms. Each pulse of the predetermined PWM signal triggers the image forming module to read the image from the documents 97 once.

When the image sensor 1 is triggered by the first pulse of the trigger signal (indicator a in FIG. 9) to read the image (FIG. 4a) from the documents 97, the image is converted to the digital image by the A/D converter 3. The image is set to the base image and stored in the memory unit 5. When the image sensor 1 is triggered by the second pulse of the trigger signal (indicator b in FIG. 9) to read the image (FIG. 4b) from the documents 97, the image is converted to the digital image by the A/D converter 3. The image is set to the reference image.

The offset between the base image and the reference image is 1.8 mm. The processor 4 calculates the offset and the interval time between the first pulse and the second pulse of the trigger signal to produce the reference speed value which is 0.6 mm/ms.

Because the predetermined speed value is equal to the reference speed value, the PWM circuit 6 still produces the predetermined PWM signal and sends the predetermined PWM signal to the image forming module 95. Therefore, the image forming module 95 still reads the image from the documents 97 one every 1 ms. The reference image is set to the base image and stored in the memory unit 5.

When the image sensor 1 is triggered by the third pulse of the trigger signal (indicator c in FIG. 9) to read the image (FIG. 4c) from the documents 97, following operation of the magnification controlling system 100 is the same as above description.

Please refer to FIG. 6a, FIG. 6b, FIG. 6c and FIG. 10. The trigger signal has several pulses for triggering the sensor module 1 to read the image from predetermined area of the documents 97. Each pulse is between 3 millisecond (ms). Therefore, the sensor module 1 reads the image from the predetermined area of the documents 97 once every 3 ms.

In this case, the predetermined speed vale is 0.6 millimeter/ms (mm/ms) which is stored in the memory unit 5. The PWM circuit 6 produces a predetermined PWM signal and sends the predetermined PWM signal to the image forming module 95. In this case, the predetermined PWM signal has several pulses. Each pulse of the predetermined PWM signal is between 1 ms. Each pulse of the predetermined PWM signal triggers the image forming module to read the image from the documents 97 once.

When the image sensor 1 is triggered by the first pulse of the trigger signal (indicator a in FIG. 10) to read the image (FIG. 6a) from the documents 97, the image is converted to the digital image by the A/D converter 3. The image is set to the base image and stored in the memory unit 5. When the image sensor 1 is triggered by the second pulse of the trigger signal (indicator b in FIG. 10) to read the image (FIG. 6b) from the documents 97, the image is converted to the digital image by the A/D converter 3. The image is set to the reference image.

Therefore, the offset between the base image and the reference image is 1.2 mm. The processor 4 calculates the offset and the interval time between the first pulse and the second pulse of the trigger signal to produce the reference speed value which is 0.4 mm/ms.

Because the predetermined speed value is not equal to the reference speed value, the processor 4 calculates the predetermined speed value and the reference speed value to produce the control signal and sends the control signal to the PWM circuit 6. Because the reference speed value is two third of the predetermined speed value, the PWM circuit 6 adjusts the PWM signal to increase interval time between each pulse of the PWM signal. In this case, the PWM circuit 6 produces a pulse every 1.33 ms to decrease one third of scanning speed of the image forming module 95.

When the image sensor 1 is triggered by the third pulse of the trigger signal (indicator c in FIG. 10) to read the image (FIG. 6c) from the documents 97, following operation of the magnification controlling system 100 is the same as above description. In this case, the offset between the base image (FIG. 6b) and the reference image (FIG. 6c) is 1.8 mm. The processor 4 calculates the offset and the interval time between the first pulse and the second pulse of the trigger signal to produce the reference speed value which is 0.6 mm/ms.

Because the predetermined speed value is equal to the reference speed value, the PWM circuit 6 still produces the PWM signal and sends the PWM signal to the image forming module 95. Therefore, each pulse of the PWM signal is between 1.33 ms which is produced by the PWM circuit 6 to decrease one third of scanning speed of the image forming module 95. The reference image is set to the base image and stored in the memory unit 5.

Scanning speed of the image forming module 95 of the scanner is controlled by the PWM signal produced by the PWM circuit 6 of the magnification controlling system 100. Therefore, the magnification controlling system 100 controls magnification of the electronic image read by the image forming module 95.

The sensor module 1 of the magnification controlling system 100 reads the images from the documents 97 conveyed by the feeding roller 93 of the scanner. The processor 4 of the magnification controlling system 100 calculates the images and then sends the control signal to the PWM circuit 6. The PWM circuit 6 produces the PWM signal according to the control signal to the step motor 94 or the image forming module 95 of the scanner.

Therefore, convey speed of the feeding roller 93 corresponding to rotation speed of the step motor 94 is controlled by the PWM signal to control magnification of the electronic images read by the image forming module 95. Also, scanning speed of the image forming module 95 is controlled by the PWM signal to control the magnification of the electronic images.

Furthermore, the present invention is not limited to the embodiments described above; various additions, alterations and the like may be made within the scope of the present invention by a person skilled in the art. For example, respective embodiments may be appropriately combined.

What is claimed is:

1. A magnification controlling system used in an image forming apparatus for controlling document conveying speed of said image forming apparatus, said image forming apparatus defining a feeding path, seen from one end of said feeding path to the other end of said feeding path is a feeding module for catching and conveying a document, a image forming module for forming an image of said document and a extracting roller for conveying said document to exit said feeding path, said magnification controlling system comprising:
a sensor module arranged between said feeding module and said image forming module for reading images from said document conveyed at a predetermined speed;
an analog-to-digital converter converting said images into digital images;
a processor calculating said digital images to produce a reference speed and then calculating said reference speed and said predetermined speed to produce a control signal; and
a pulse producing circuit providing pulse signals to said step motor of said image forming apparatus in a predetermined time according to said control signal, wherein number of said pulse signals in said predetermined time is corresponding to said document conveying speed.

2. The magnification controlling system as claimed in claim 1, wherein said feeding module has a catching roller, a separating roller, a feeding roller and a step motor connected to said feeding roller.

3. The magnification controlling system as claimed in claim 1, wherein said pulse producing circuit is a pulse width modulation circuit.

4. The magnification controlling system as claimed in claim 1, wherein said image forming apparatus is a scanner.

5. The magnification controlling system as claimed in claim 1, wherein said sensor module has a lamp and a sensor, said lamp lights a predetermined area of said document and said sensor reads said image from said predetermined area of said document.

6. The magnification controlling system as claimed in claim 4, wherein said lamp is a light-emitting diode, said sensor is a charge-coupled device.

7. The magnification controlling system as claimed in claim 1, further comprising an amplifier for amplifying said image read by said sensor module and sending amplified image to said analog-to-digital converter.

8. The magnification controlling system as claimed in claim 1, further comprising a memory unit storing value of said predetermined speed.

9. The magnification controlling system as claimed in claim 2, wherein said pulse producing circuit sends said pulse signals to said step motor of said image forming apparatus for controlling rotation speed of said step motor corresponding to said document conveying speed.

10. The magnification controlling system as claimed in claim 1, wherein number of said pulse signals in said predetermined time produced by said pulse producing circuit is increased when said reference speed is below said predetermined speed.

11. A controlling method of a magnification controlling system used in an image forming apparatus, comprising:
reading a first analog image from a document by a sensor module of said image forming apparatus, said document conveyed in a predetermined speed;
converting said first analog image to a first digital image by an analog-to-digital converter;
setting said first digital image to a base image and storing said base image;
reading a second analog image from said document by said sensor module of said image forming apparatus again;
converting said second analog image to a second digital image by said analog-to-digital converter again;
setting said second digital image to a reference image;
calculating said base image and said reference image to produce a reference speed;
calculating said predetermined speed and said reference speed to provide plurality of pulse signals in a predetermined time, wherein number of said pulse signals in a predetermined time is corresponding to magnification of an electronic image produced by said image forming apparatus; and
setting said reference image to said base image.

12. The controlling method of said magnification controlling system as claimed in claim 11, wherein said pulse signals are sent to a step motor of said image forming apparatus for controlling document conveying speed, number of said pulse signals in said predetermined time is increased when said reference speed is below said predetermined speed.

13. The controlling method of said magnification controlling system as claimed in claim 11, wherein said pulse signals are sent to an image forming module of said image forming apparatus for controlling scanning speed of said image forming module, number of said pulse signals in said predetermined time is decreased when said reference speed is below said predetermined speed.
